(19) United States
(12) Patent Application Publication
(10) Pub. No.: US 2005/0048452 A1
(43) Pub. Date: Mar. 3, 2005

(54) Sports training apparatus and method of using same

(76) Inventor: Louis-Georges Dufour, Ste-Foy (CA)

Correspondence Address: TESTA, HURWITZ & THIBEAULT, LLP, HIGH STREET TOWER, 125 HIGH STREET, BOSTON, MA, 02110, US

(21) Appl. No.: 10/856,739

(22) Filed: May 28, 2004

(30) Foreign Application Priority Data
May 29, 2003 (CA) 2,430,049 CA

(51) Int. Cl. A63H 13/00; A63H 11/10; A63B 69/00; G09B 19/00; G09B 9/00

(52) U.S. Cl. 434/247

(57) ABSTRACT

The present invention generally relates to a sport training apparatus and more specifically, the present invention is concerned with an apparatus for training a person in doing body movements for various sports or activities, such as for example body rotations in figure skating. For a new learner or for a performer wanting to enhance his/her rotation techniques, the steps in performing such body movements and the subtleties in the techniques may need intensive monitoring from a teacher and require repetitions to develop good reflexes in achieving the body movements. The apparatus of the present invention includes an elongated body for the positioning of each hand in the vicinity of each other to help perfect the body rotation of the performer.

### CROSS-REFERENCE TO RELATED APPLICATION

This application claims priority to and the benefit of Canadian Patent Application No. 2,430,049, filed May 29, 2003, the disclosures of which are incorporated herein by reference.

### FIELD OF THE INVENTION

The present invention generally relates to sport training apparatuses. More specifically, the present invention is concerned with an apparatus for training a person in doing body rotations.

### BACKGROUND OF THE INVENTION

In many sports such as for example figure skating, gymnastics, diving or acrobatic ski, the positioning of the body and of the body members is crucial to the quality of execution of a specific movement or required figures in a routine.

Amongst those movements, the rotation of the body upon itself is generally preformed along the vertical body axis of the performer. Various parameters may affect the quality and the speed of the rotation, such as, for example, the position and the momentum of the body upon entry into the rotation and the position of the body members during the execution of the rotation.

The different steps of the movement of rotation will be briefly described as used in figure skating, for a counter clockwise direction. Of course, the same principles would apply in the clockwise direction using the opposite side of the body and rotating in the opposite direction. There are many different factors involved in the creation of rotation but the following description will be specifically concentrated on the arm movements as it is the arms and the upper body that are mainly implicated in every steps of the jump and spins from entry into the rotation to finish or landing of the rotation.

Initiation of the Rotation

The rotation is generally initiated by the right side of the body doing a half circle, starting from the back of the body and coming to the front of the left side of the body. Therefore, the right arm will be doing a half circle starting from the back of the body and coming to the front of the body. Meanwhile the left arm is doing a one quarter of a circle, starting from the left side of the body and coming to the front. The rotation is mainly initiated by the right side of the body going in the same direction as the rotation.

Rotation Position

As both hands arrive in front of the body, generally at shoulder's height, the arms form a circle, which is more or less ellipsoidal, depending on the desired technique.

Acceleration of the Rotation

The acceleration of the rotation is generally induced by the arms, being in the above-described rotation position, which go from being far from the body to being close to the body. The acceleration principle may be explained by the fact that the overall body inertia is brought closer to the axis of rotation of the rotation performer as his/her arms are brought closer to his/her body.

Deceleration of the Rotation

The deceleration of the rotation generally happens when the movements of the arms go from being close to the body to being far from the body.

Landing or Finish

The landing or finish of spin will result in a complete stop or exit of the rotation. One way to achieve this step is to have the right hand, the right arm and the right side of the body go in the opposite direction of the rotation. The right arm may therefore have to do a one quarter of a circle, going from the front of the body to the side of the body. To help position and balance the body over the landing side, the figure skaters generally use a movement of arms that will help transfer the weight from being centered to being over the landing side.

For an apprentice or for a performer wanting to enhance his/her rotation techniques, the supervision of a professional trainer or teacher may be sought. However, due to the fact that some movements, such as for example body rotations, are often executed at high speeds and that for at least some time during the execution of the movements, the performer is not in front of the teacher, it may be difficult for a teacher to properly monitor every subtlety in the movement and thus properly guide the performer.

It may also be important for some apprentices or performers to visualize the movements that are taught, such that with time and practice, the position of the body members become reflexes imprinted in their mental and physical memory, which may therefore help enhance body movement precision, speed, pace, repetition and duration of the movement.

### OBJECTS OF THE INVENTION

An object of the present invention is therefore to provide an apparatus which helps a performer in executing body movements requiring precise positioning of the hands, such as for example body rotations.

A further object of the present invention is to provide a method of using an apparatus which integrates sensorial markers, such as for example visual, auditive and/or tactile markers, to help train, teach or develop the body movement techniques.

### SUMMARY OF THE INVENTION

Generally stated, the present invention concerns a sports training apparatus for training a person in performing body movements such as for example body rotations. The apparatus is also generally used with a method helping to teach and learn a body position which may be used in many sports that require performance of such body movements, such as for example figure skating, diving, gymnastics and acrobatic skiing.

More specifically, in accordance with a first aspect of the present invention, there is provided a apparatus for training a person in doing rotations; the apparatus comprising a body having a first handle portion for receiving a first hand of the person and a second handle portion positioned adjacent said first handle portion for receiving a second hand of the person adjacent the first hand; whereby, in operation, the person holds said first handle portion of the apparatus with said first hand before initiating a rotation and then holds both the first and second handle portions using both hands after initiating the rotation, to force both hands to being adjacent, thereby contributing to perfecting the rotation.

An apparatus for positioning both hands of a person while performing a body movement, said apparatus comprising:
a body including a first handle portion and a second handle portion which is movably mounted to said first handle portion; and
a stopper radially extending from said body near one end of said first handle portion;
whereby upon performing the body movement, a first hand is positioned on said first handle portion and in contact with said stopper, and the other hand is positioned on said second handle portion adjacent to the first hand.

A method for teaching a person in doing rotations, said method:
a) providing to the person a body having a first handle portion and a second handle portion positioned adjacent said first handle portion;
   the person:
b) positioning a first hand on said first handle portion of said body;
c) generating the momentum to create the rotation along a rotation direction;
d) positioning a second hand on said second handle portion of said body and positioning both hands adjacent to one another in front of him;
e) bringing the hands holding said body close to him;
f) moving the arms from being generally in front of him in an opposite direction to said rotation direction; and
g) releasing the second hand from said second handle portion.

It is to be noted that the in the present description and in the appended claims, references to the terms “first” and “second” are only used herein for clarity and are interchangeable with respect to the drawings.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a side elevation view of a sports training apparatus according to a first embodiment of a first aspect of the present invention;

FIG. 2 is a side elevation view showing a second embodiment of a first aspect of the present invention;

FIG. 3 is a side elevation view showing a third embodiment of a first aspect of the present invention;

FIG. 4 is a side elevation view showing a fourth embodiment of a first aspect of the present invention;

FIG. 5 is a side elevation view showing a fifth embodiment of a first aspect of the present invention;

FIG. 6 is a side elevation view showing an angled configuration of the apparatus of FIG. 5;

FIG. 7 is a perspective view showing a sixth embodiment of a first aspect of the present invention;

FIG. 8 is a perspective view showing a rotated configuration of the apparatus of FIG. 7;

FIG. 9 is a fragmentary sectional side view of the apparatus of FIG. 7;

FIG. 10 is fragmentary sectional side view showing an assembled configuration of the apparatus of FIG. 7;

FIG. 11 is a fragmentary sectional side view showing a seventh embodiment of a first aspect of the present invention;

FIG. 12 is a fragmentary sectional side view showing an eight embodiment of a first aspect of the present invention;

FIG. 13 is a side elevation view showing a ninth embodiment of a first aspect of the present invention;

FIG. 14 is a side elevation view of the apparatus of FIG. 13;

FIG. 15A is a side elevation view showing a first step in a method for teaching a person in doing rotations according to an embodiment of a second aspect of the invention;

FIG. 15B is a side elevation view showing an alternative to the first step of FIG. 15A;

FIG. 16A is a top view showing a second step in a method for teaching a person in doing rotations according to the second aspect of the invention;

FIG. 16B is a side elevation view showing the second step of FIG. 16A;

FIG. 17 is a side elevation view showing a third step in a method for teaching a person in doing rotations according to the second aspect of the invention;

FIG. 18 is a side elevation view showing a fourth step in a method for teaching a person in doing rotations according to the second aspect of the invention;

FIG. 19 is a top view showing the fourth step of FIG. 18;

FIG. 20 is a top view showing a fifth step in a method for teaching a person in doing rotations according to the second aspect of the invention;

FIG. 21 is a top view showing a sixth step in a method for teaching a person in doing rotations according to the second aspect of the invention;

FIG. 22A is a top view showing an seventh step in a method for teaching a person in doing rotations according to the second aspect of the invention;

FIG. 22B is a side elevation view showing the seventh step of FIG. 22A; and

FIG. 23 is a top view showing an eight step in a method for teaching a person in doing rotations according to the second aspect of the invention.

### DETAILED DESCRIPTION

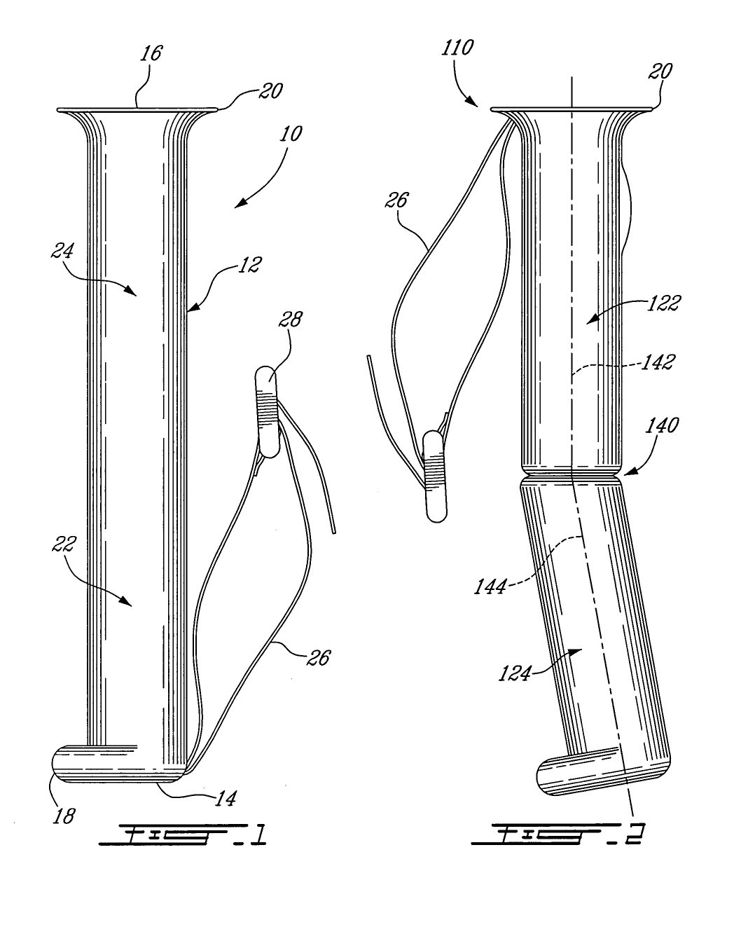

An apparatus 10 for training a person in performing rotations according to a first illustrative embodiment will now be described with reference to FIG. 1.

As illustrated in FIG. 1, the apparatus 10 comprises a cylindrical body 12 having first and second longitudinal ends 14 and 16, each provided with a circumferential protrusion defining first and second stoppers 18 and 20.

The first half of the body 12 extending from the first longitudinal end 14 and including the first stopper 18 defines a first handle portion 22 for receiving a first hand of a user and the second half of the body 12 extending from the second longitudinal end 16 and including the second stopper 20 defines a second handle portion 24 for receiving a second hand of a user.

Moreover, the cylindrical body 12 is configured and sized so that when a user closes its hands on the cylindrical body 12 in such a way that each of its two hands abuts a respective stopper 18-20, the two hands are positioned adjacent to each other.

The apparatus 10 further comprises a strap 26 secured to the body 12 near its first longitudinal end 14. More specifically, the strap 26 is mounted in an aperture (not shown) in the stopper 18 via a fastener (not shown). The strap 26 is so configured as to be positioned around the wrist of the first hand when positioned on the second handle portion 24.

The strap 26 includes an adjuster 28 to adjust the length of the strap 26 around the wrist of the hand to handle the second handle portion 24. Such an adjuster 28 is believe to be well known in the art and will not be described herein in more detail for concision purposes. The form of the adjuster 28 can modified without departing from the spirit and nature of the present invention. Also, the apparatus 10 can be provided with a strap 26 having a predetermined fixed length.

As will become more apparent from further reading of the present description, the stoppers 16 and 18 help positioning the hands of a user on the body 12, while contributing to preventing slippage of the hands onto the body 12. As illustrated in FIG. 1, the stoppers 18 and 20 can have different shapes.

Alternatively to being cylindrical, the body 12 can have other constant or varying cross-sections.

The body 12 can also be made of any rigid or partially deformable materials such as: plastic, rubber, wood, metal, etc. and may be made hollow to be lighter.

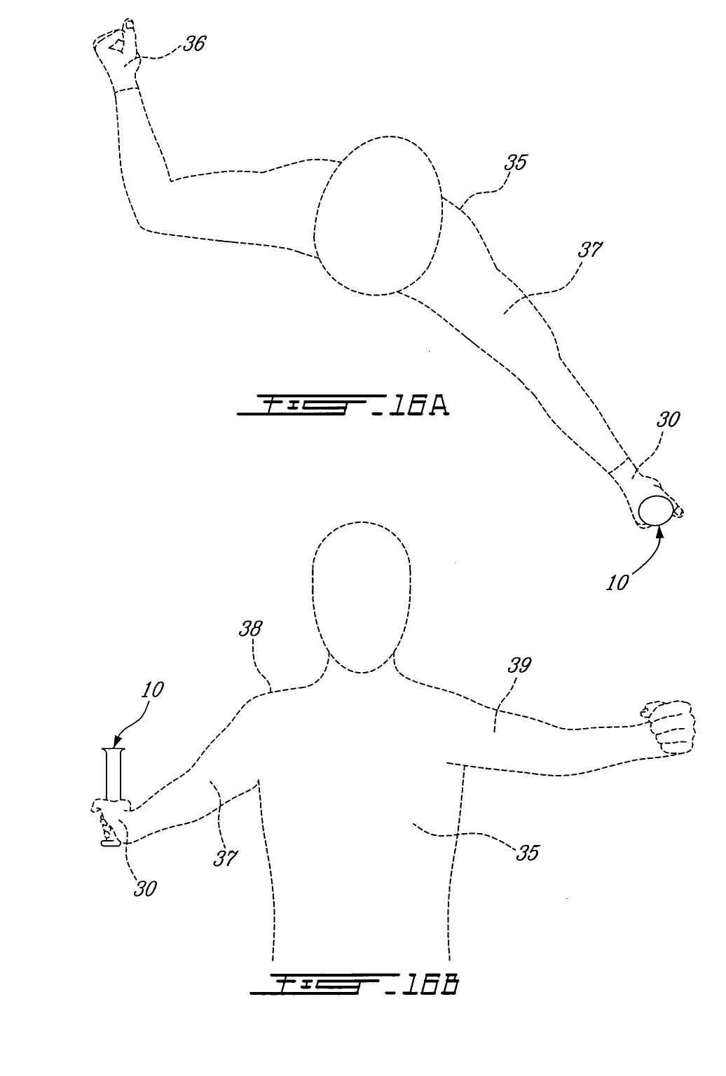

The operation of the apparatus 10 will now be described with reference to FIGS. 15A-23 illustrating a method for teaching a person in doing rotations according to an illustrative embodiment of a second aspect of the present invention. Even though such rotations are performed in various sports and activities, the method will be described for a person executing counter-clockwise body rotations in figure skating.

One Hand Holding the Apparatus

As seen in FIG. 15A and 15B, a first hand 30 of the person holds the first handle portion 22 of the apparatus 10 with the strap 26 positioned around the wrist 31. In FIG. 15A, the thumb 32 and the index 33 of the hand 30 are positioned adjacent to the stopper 18. In FIG. 15B, which illustrates and alternative handling of the apparatus 10 by the first hand 30, the little finger 34 of the hand 30 is positioned adjacent to the stopper 18. Using the adjuster 28, the length of the strap 26 is adjusted around the wrist 31.

It is to be noted that for the remainder of the description of the operation of the apparatus 10, the alternative handling of the apparatus 10 shown in FIG. 15B will be used. It is also to be noted that the strap 26 is not illustrated on all the appended figures, for clarity purposes.

Initiating the Rotation

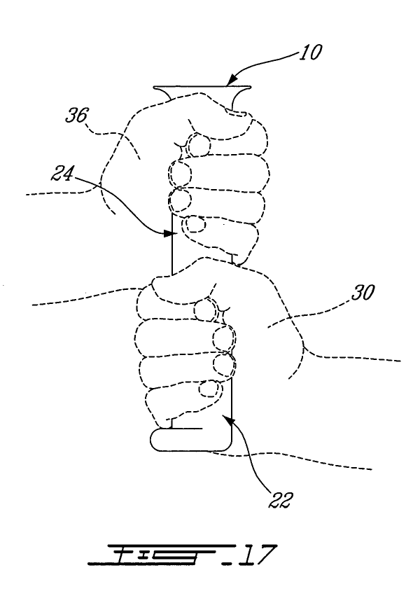

At the beginning of the initiation of the rotation by the person using its body 35, the hands 30, 36 are generally apart as shown in FIGS. 16A and 16B, but one hand 30 is holding the apparatus 10.

The angle in which the apparatus 10 is held generally helps determine the direction of the movement of the arm holding the apparatus 10, such that when held in the right hand 30, the angle will help direct the movement of the right arm 37.

As shown in FIG. 16B, the apparatus 10 is pointed up with the palm of the hand 30 facing forward. This position generally induces a rotation of the right shoulder 38 toward the back. This opening of the right shoulder 38 generally helps to guide the right arm 37 toward the front to favor a movement of the right arm 37 in a generally upward direction, from the back of the front of the body 35.

Various angles in holding the apparatus 10 may also help have various directions of movements for the right and left arms. For example, the apparatus 10 may also be held pointing forward with the palm of the hand facing down. This configuration generally helps to place the right shoulder 38 parallel with the body 35 such that the right arm 37 is also parallel to the body 35.

The apparatus 10 may also be held pointing downward with the palm of the hand 30 facing backward. This configuration generally helps to induce a rotation of the right shoulder 38 toward the front to favor a movement of the right arm 37 in a downward direction, from the back of the body 35 to the front of the body 35.

The same principle applies to the left arm 39 regarding the direction of the movement from the side of the body and coming to the front of body.

The user then brings both hands in front of him to begin the rotation.

Two Hands Hold the Apparatus

As seen in FIG. 17, both hands 30 and 36 are joined together in front of the body 35 as the second hand 36 grabs the second handle portion 24. The user is now in a rotation position.

The Open Rotation Position

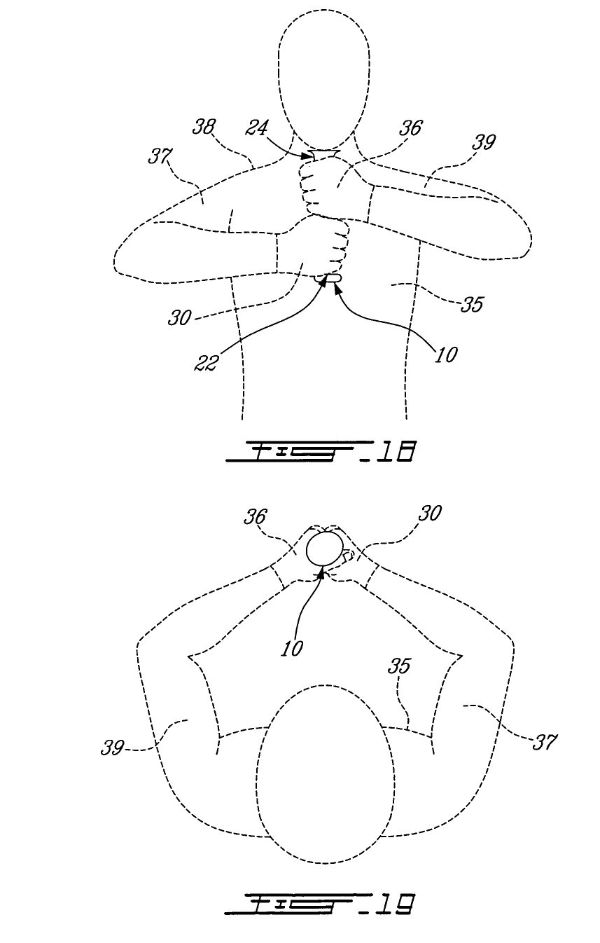

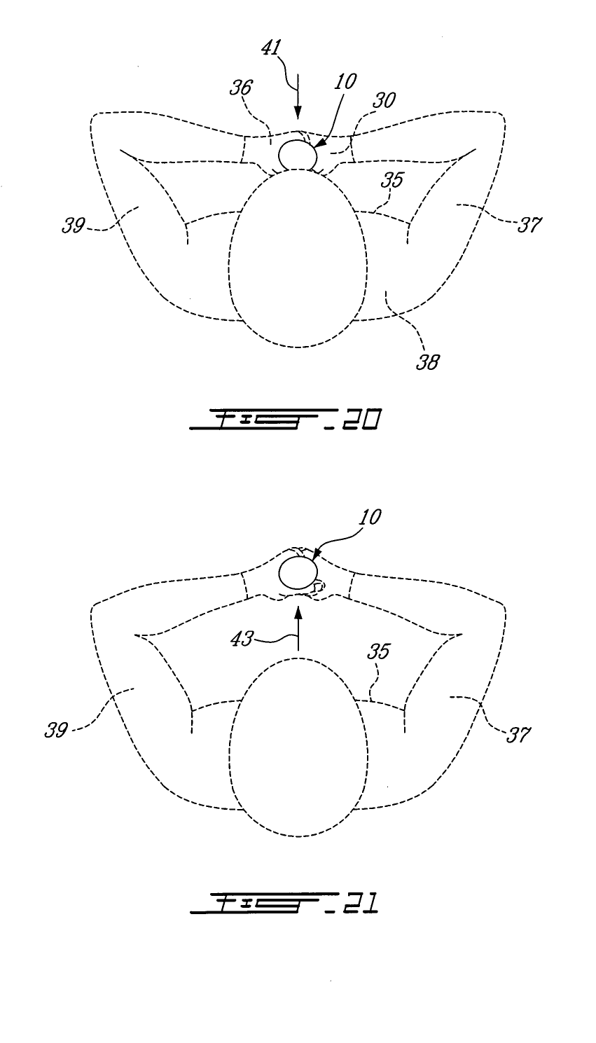

The rotation position illustrated in FIGS. 18 and 19 is an open rotation position, which involves having both hands 30 and 36 being joined together on the apparatus 10. The apparatus 10 is held in front of the body 35, generally at the shoulders 38 height and at a distance of about 35 cm (about 14 inches) of the body 35. However, the distance and height of the apparatus 10 may vary according to the desired open rotation position or according to the size and age of the person using the apparatus 10.

As can be better seen from FIG. 19, the arms 37, 39 generally form a circle more or less ellipsoidal, depending on the desired technique. The apparatus 10 helps to have both hands 30, 36 generally aligned one above the other and at a generally equal distance of the body 35, in order to have an optimized symmetric rotation position. The apparatus 10 also help to generally maintain the same rotation position throughout the performance of the rotation.

It is to be noted that during the performance of a jump or an exercise that requires faster execution or faster rotation, this step may be avoided.

The Acceleration of Rotation

The acceleration of the rotation generally occurs when the arms 37, 39, which are in the open rotation position of FIG. 19, generally go from being far from the body 35 to being close to the body 35 (see arrow 41 in FIG. 20). The apparatus 10 helps synchronously bring both arms 37, 39 closer to the body 35 by keeping the arms 37, 39 generally aligned and symmetric one to the other. The apparatus 10 also generally helps determine and control the speed and the direction of the movement of the arms 37, 39 during the acceleration of the rotation.

As seen in FIG. 20, the second rotation position is a closed rotation position, involving both hands 30, 36 being joined together on the apparatus 10. At that stage, the apparatus 10 is generally held in front of the body 35, at the shoulders 38 height and at a distance of about 0 to 5 centimeters (about 2 inches) from the body 35. However, the distance and height of the apparatus 10 generally varies according to the desired closed rotation position.

The apparatus 10 generally helps determine and control the desired distance between the arms 37, 39 and the body 35 during the performance of the rotation. The apparatus 10 is generally held in the center of the body 35, at a generally equal distance of the shoulders 38. The apparatus 10 generally helps to have a symmetric rotation position.

An alternative to the closed rotation position involves the apparatus 10 being generally aligned over the landing side. In the case of a rotation in the counter clockwise direction, the apparatus 10 is held closer to the right shoulder than the left shoulder.

The Deceleration of Rotation

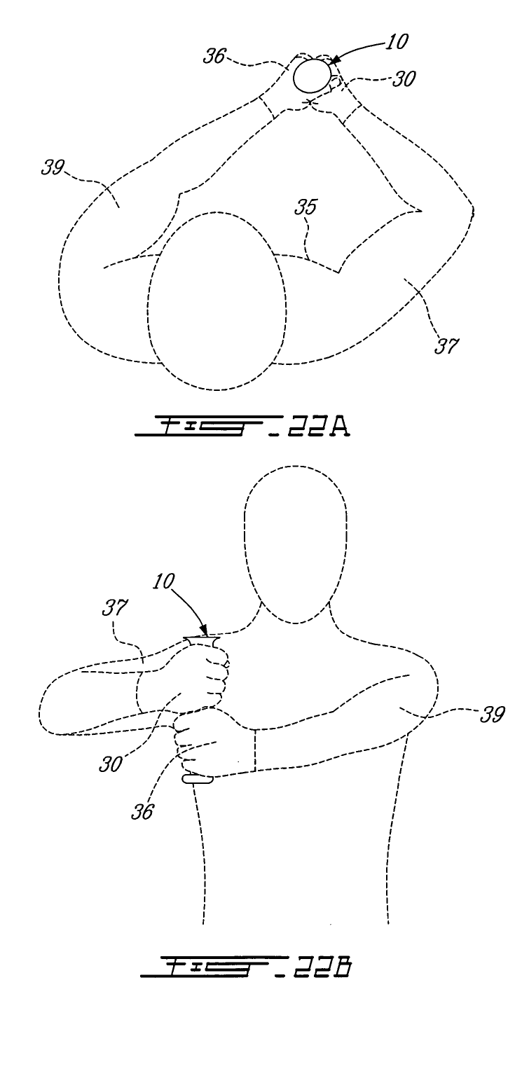

The deceleration of the rotation is illustrated in FIG. 21 and generally happens with the movement of the arms 37, 39 go from being close to the body 35 to being far from the body 35 (see arrow 43 in FIG. 21). The apparatus 10 generally helps the symmetry and the synchronization of both arms 37, 39 and also helps control the speed and the direction of the movement of the arms 37, 39 during the deceleration of the rotation.

The Ending of the Rotation

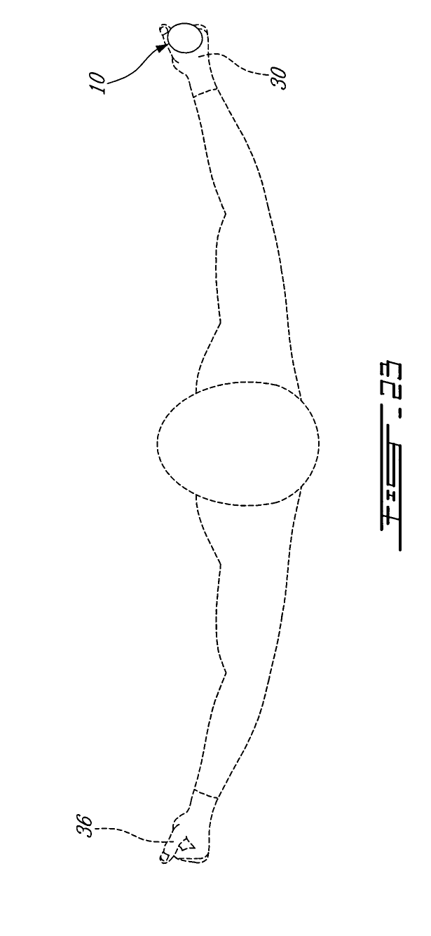

As seen in FIGS. 22A and 22B, the ending of the rotation generally happens with the movement of the arms 37, 39 going from being generally centered in front of the body 35 (as seen in FIG. 21) to going it the opposite direction of the rotation.

If the body 35 rotates in the counter clockwise direction, then both hands 30, 36 move the apparatus 10 in the clockwise direction in order to stop the rotation (as can be seen in FIGS. 22A and 22B). The apparatus 10 generally helps both hands 30, 36 move generally strongly and symmetrically in the opposite direction of the rotation. During the ending of rotation movement, the apparatus 10 generally helps the synchronization of both arms 37, 39 and also helps control the speed of that movement.

In the landing of jumps and finish of spins, the apparatus 10 also helps to transfer the weight of the body 35 over the landing side. For instance, if the rotation is in the counter clock wise direction, the landing side will be the right side. Therefore, the user may move the apparatus 10 from being in front of the body 35 to be in front of the right shoulder to help transfer the weight of the body 35 from being generally centered to being over the right side which is in this example, the landing side.

The Ending Movement

The ending movement generally happens when the second hand holding the second handle portion 24 release the apparatus 10. The apparatus 10 generally remains held by the hand 30 holding the first handle portion 22, as can be seen in FIG. 23.

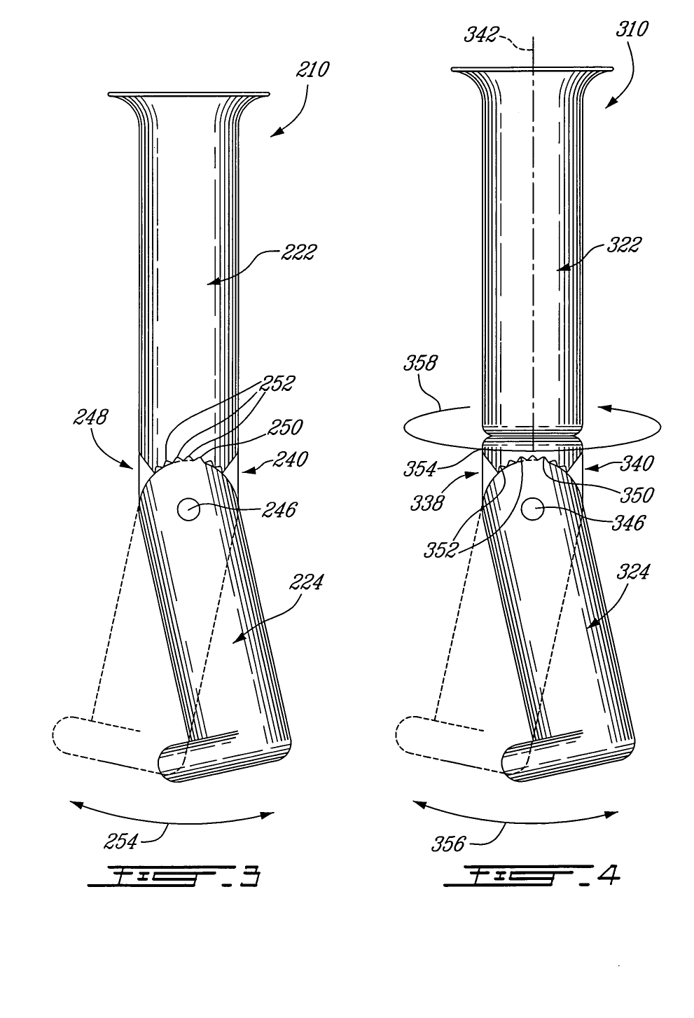

Apparatuses according to various embodiments of the first aspect of the present invention will now be described with respect to FIGS. 2 to 14. For concision purposes, only the differences between the apparatuses of the various embodiments of FIG. 2 to 14 and the apparatus 10 illustrated in will be described hereinbelow.

An apparatus 110 according to a second embodiment of the invention is illustrated in FIG. 2.

In this embodiment, the strap 26 is mounted to the stopper 20 at the second end of the apparatus 110. Furthermore, the apparatus 110 includes an articulation 140 which allows a pivotal connection between the handle portion 122 and the handle portion 124. The handle portion 122 generally extends along a first axis 142 and the handle portion 124 generally extends along a second axis 144 such that the first and second axis 142, 144 may be angled, generally parallel, or concurrent depending on the articulation 140. The articulation 140 allows different angles of grips between the first hand and the second hand when positioned on the apparatus 10.

In operation, the apparatus 110 which is provided with the articulation 140 may be integrated to the method for teaching a person in doing rotations which was described hereinabove and more specifically shown in FIGS. 17 and 18, such that when the performer of the rotation joins his two hands 30, 36, on the apparatus 110, both of his elbows are generally aligned.

An apparatus 210 according to a third embodiment of the first aspect of the present invention is illustrated in FIG. 3.

In this embodiment, the articulation 240 of the apparatus 210 includes a pivot pin 246 and a position selector assembly 248. The pivot pin 246 pivotally connects the handle portion 222 and the handle portion 224 (see arrow 254). The position selector assembly 248 projection 250 extending from the handle portion 224 which selectively cooperates with one of a plurality of notches 252 on the handle portion 222.

Various angular orientations between the handle portion 222 and the handle portion 224 are therefore available, by pivoting either or both the handle portion 222 and the handle portion 224 about the pivot pin 246, such that the projection 250 is selectively engaging the notch 252 that corresponds to the desired apparatus 210 configuration. The projection 250 and the selected notch 252 are so configured as to generally remain engaged in cooperation during the use of the apparatus 210.

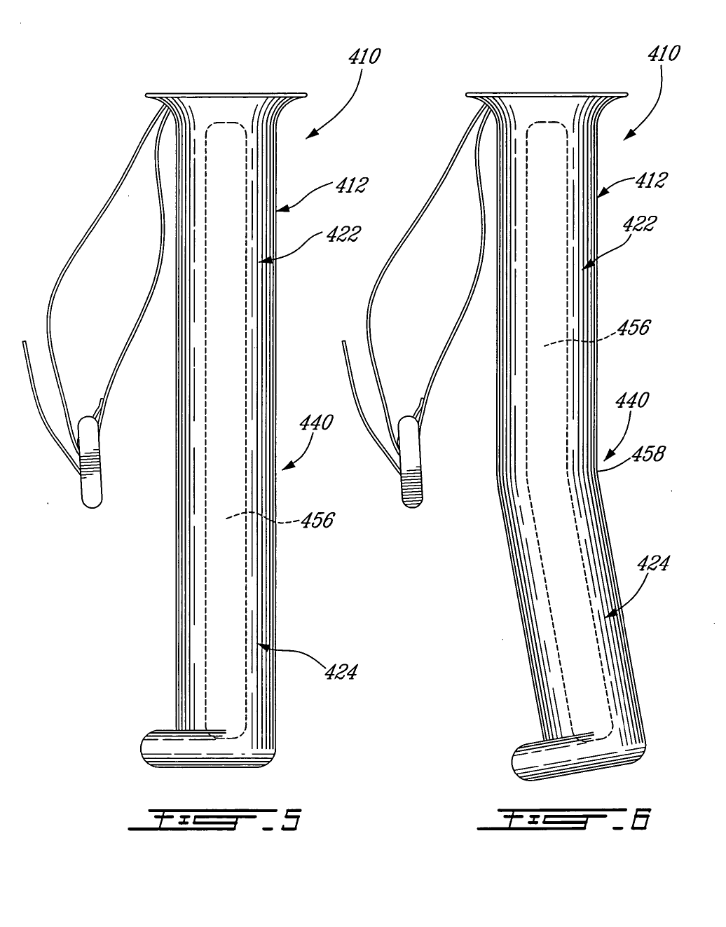

An apparatus 310 according to a fourth embodiment of the first aspect of the present invention is illustrated in FIG. 4.

In this embodiment, the articulation 340 includes a rotational body 354 which is rotatably mounted on one end to the handle portion 322 and on the other end, pivotally mounted to the handle portion 324 via the pivot pin 346.

On one end, the rotational body 354 includes the plurality of notches 352 cooperating with the projection 350 of the handle portion 324. On the other end, the rotational body 354 includes a mounting assembly (not shown) which allows to angularly position the rotational body 354 along the first axis 342 of the first handle portion 322. The mounting assembly (not shown) may be selected from a plurality of assemblies, such as for example, a similar pin and notch arrangement as described hereinabove.

The articulation 340 provides various angular orientations about the pivot pin 346, between the handle portion 322 and the handle portion 324 (see arrow 356). The presence of the rotational body 354 therefore allows a second degree of liberty between the handle portion 322 and the handle portion 324 by providing them with a second set of respective angular orientations about the first axis 342 (see arrow 358).

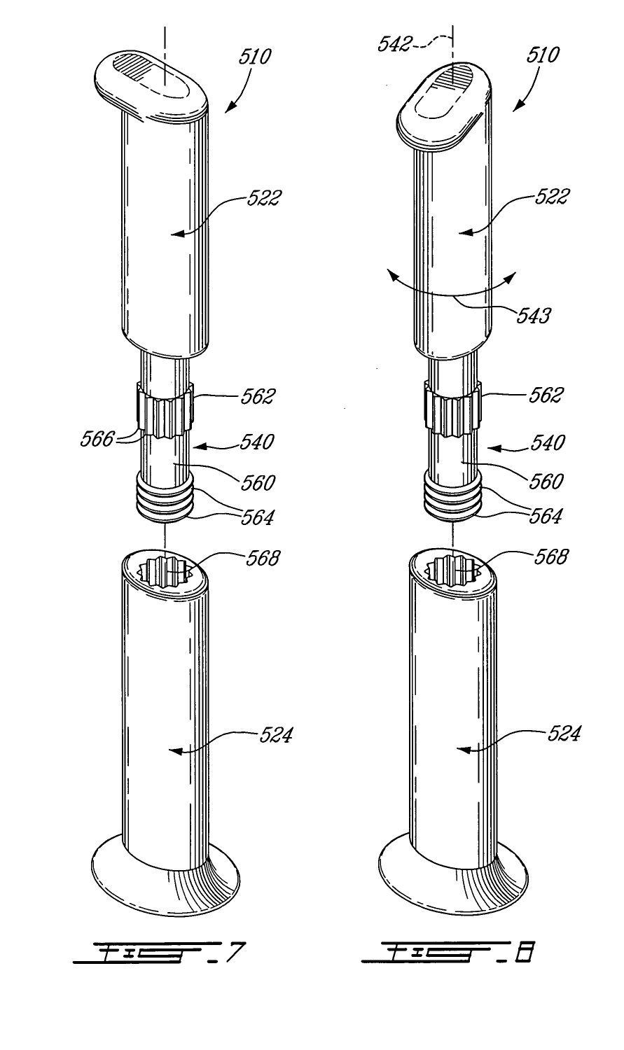

An apparatus 410 according to a fifth embodiment of the first aspect of the present invention is illustrated in FIGS. 5 and 6.

In this embodiment, the handle portion 422 and the handle portion 424 are articulated by the articulation 440 which includes a deformable bar 456 embedded in the body 412 and which deforms under a predetermined level of force. In this embodiment, the body 412 of the apparatus 410 is generally malleable such that it follows the contour configuration defined by the deformable bar 456.

In FIG. 5, the apparatus 410 is shown with a generally rectilinear configuration, i.e. when no bending force is applied thereto. In FIG. 6, the handle portion 424 is angled with respect to the handle portion 422 at a bend 458 a force exerted to the articulation 440.

As seen in FIG. 6, it is easily understood to one skilled in the art that it is possible to generate more than one angle to the deformable bar 456, such that the handle portion 422 and the handle portion 424 may be relatively positioned at different angular positions.

For instance, the handle portion 422 and the handle portion 424 may be positioned in a horseshoe configuration, in a S-shape configuration or any other configurations allowing the positioning of a first hand on the first handle portion 422 and a second hand to a second handle portion 424, such that they are either closer or farther from each other to suit various uses of the apparatus 410. The deformation of the deformable bar 456 may be either elastic or plastic, depending on the material used to make the bar 456.

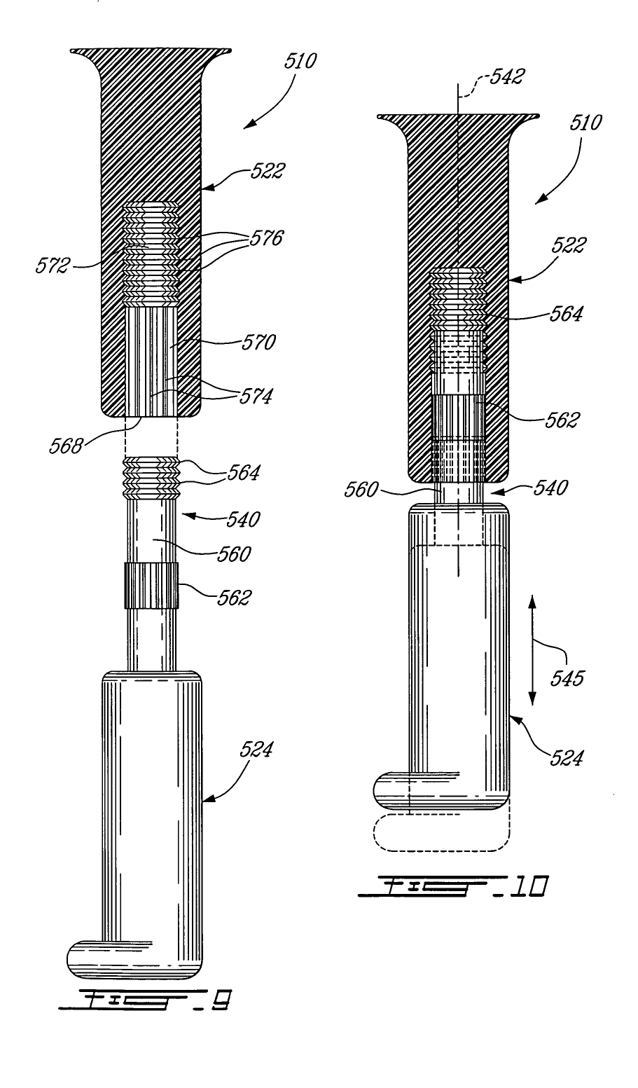

An apparatus 510 according to a sixth embodiment of the first aspect of the present invention is illustrated in FIGS. 7 to 10.

In FIG. 7 and 8, it is shown that the handle portion 522 and the handle portion 524 are made from two separate parts, one fitting in the other and kept together by the articulation 540 which, in this embodiment, involves a connection between the handle portion 522 and the handle portion 524. The articulation 540 is so configured as to generate a removable attachment between both handle portions 522 and 524 and yet allow movement between the two.

The handle portion 522 and the handle portion 524 have generally ellipsoidal cross sections which are aligned or not, depending on the use of the apparatus 510. The articulation 540 generally extends from one end of the handle portion 522 and includes a body 560 supporting a gear 562 and a plurality of annular rings 564.

The gear 562 includes a plurality of teeth 566 and the annular rings 564 are made from a mechanically compliant material which elastically deforms under a force while generally keeping its physical and functional integrity.

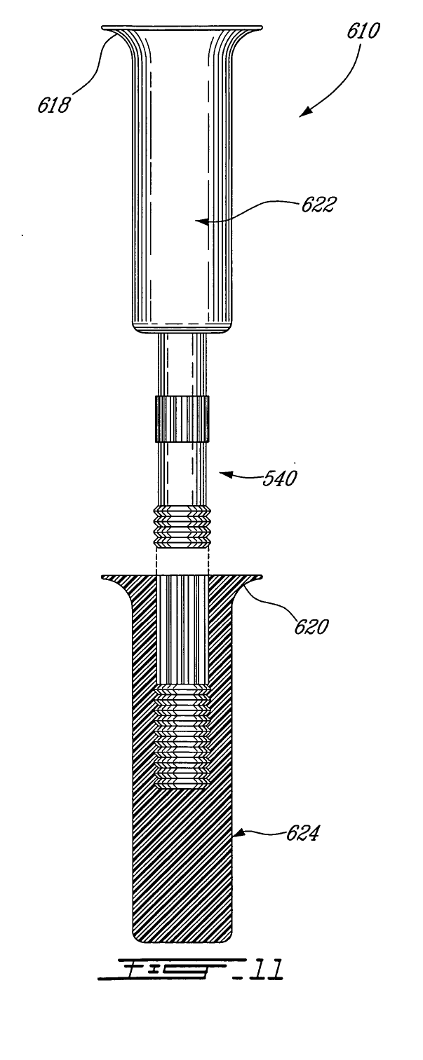

As illustrated in FIG. 9 and 10, the handle portion 524 includes on one end a female portion 568 so configured as to receive the articulation 540. The female portion 568 includes a teeth receiving portion 570 and a ring receiving portion 572.

The teeth receiving portion 570 includes a succession of grooves 574 adapted to mesh with the teeth 566 of the articulation 540, such that a plurality of angular positions between the handle portion 522 and the handle portion 524 are defined around the first axis 542, as shown by the arrow 543 in FIG. 8.

The ring receiving portion 572 includes a succession of grooves 576 adapted to receive the rings 564 of the articulation 540, such that a plurality of axial positions between the first handle portion 522 and the second handle portion 524 are defined along the first axis 542, as shown by the arrow 545 in FIG. 10.

The rings 564 are first inserted in the female portion 568 toward the ring receiving portion 572. At one point after the insertion of the articulation 540 in the female portion 568, the teeth 566 engage the grooves 574, corresponding to the selected relative angular orientation around the first axis 542 and between the first handle portion 522 and the second handle portion 524. The rings 564 then selectively engage the ring receiving portion 572 until the desired length of the apparatus 510 is obtained.

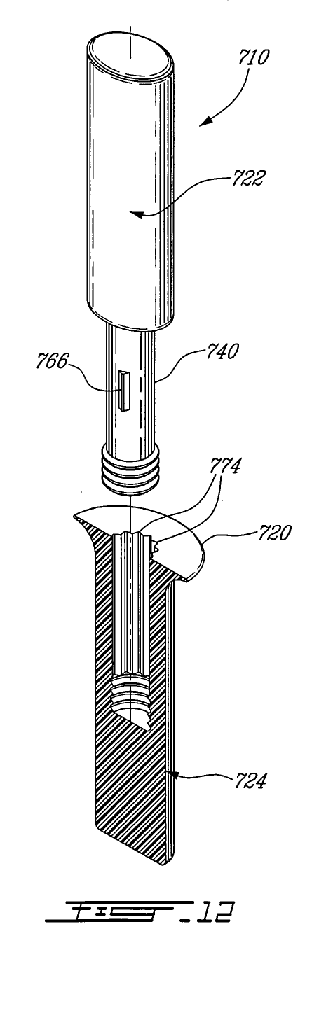

An apparatus 610 according to a seventh embodiment of the first aspect of the present invention is illustrated in FIG. 11.

In this embodiment, the handle portion 622 and the handle portion 624 include identical stoppers 618, 620. Also, the second stopper 620 is positioned adjacent to the first handle portion 622. The articulation 540 of the embodiment of FIGS. 7 to 10 is also used.

An apparatus 710 according to an eight embodiment of the first aspect of the present invention is illustrated in FIG. 12.

In this embodiment, only the handle portion 724 includes a stopper 720. Also, only one tooth 766 is fixedly mounted on the articulation 740, to engage one of the grooves 774 corresponding to the selected relative orientation between the first handle portion 722 and the second handle portion 724.

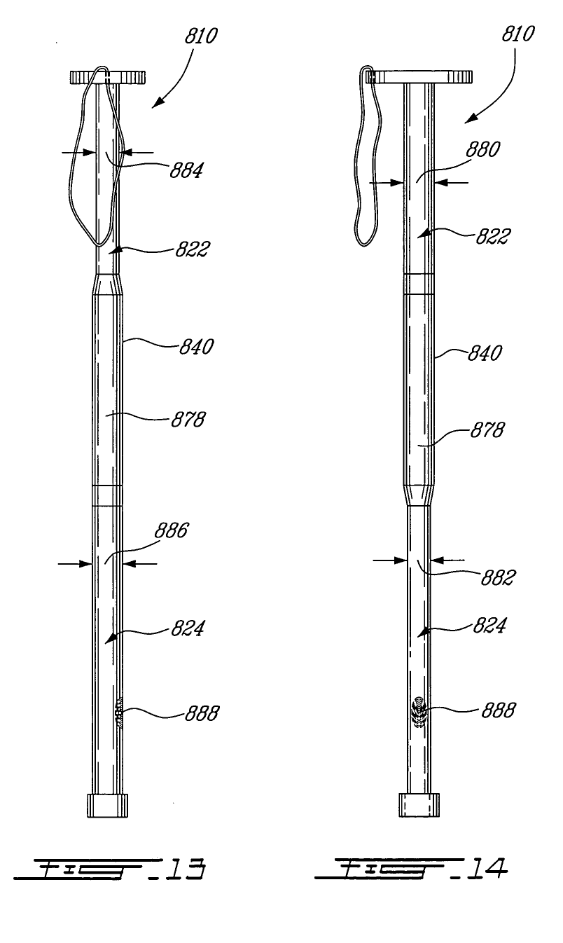

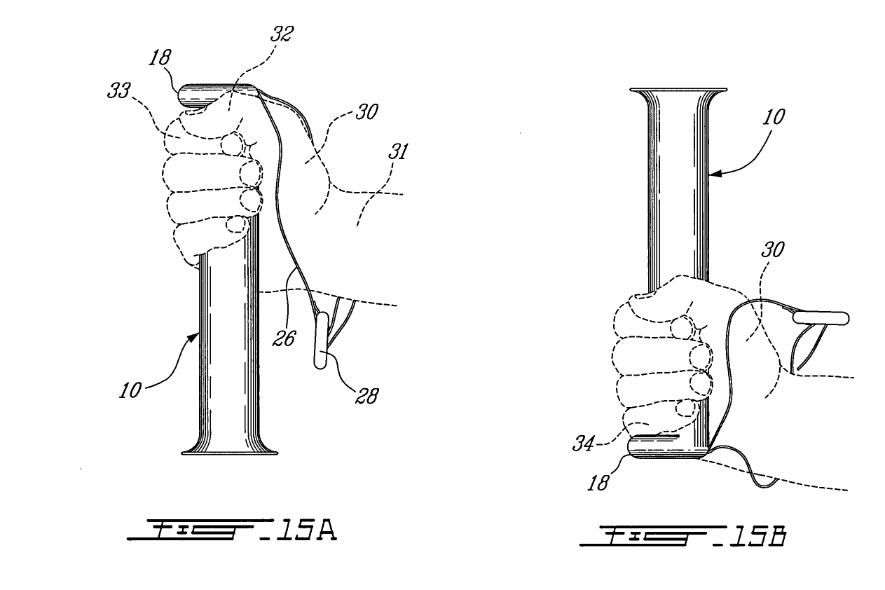

An apparatus 810 according to a ninth embodiment of the first aspect of the present invention is illustrated in FIGS. 13 and 14.

In this embodiment, the articulation 840 includes a telescopic body 878 variable in length to allow the hands of the user of the apparatus 810 to be close or far from each other, by varying the distance between the handle portion 822 and the handle portion 824.

As illustrated in FIG. 14, the handle portion 822 has a generally oval cross-section having its greater axis 880 generally in the same plane as the smaller axis 882 of the generally oval cross-section of the handle portion 824. The generally oval cross-section of the handle portion 822 has its smaller axis 884 in the same plane as the greater axis 886 of the generally oval cross-section of the handle portion 824, as shown in FIG. 13.

Since the cross-sections of the handle portion 822 and the handle portion 824 have different axis 880, 884 and 882, 886, the handle portions 822, 824 are so configured as to align the hands along a desired angular alignment with respect to each other. In the shown embodiment, the hands are to be respectively aligned at a relative 90 degree angle on the handle portions 822, 824.

Also, a sensor 888 trigger a sound, light or a signal from an emitter (not shown) to inform the user that his/her hands are properly positioned on the apparatus 810 when in contact with the sensor 888. The sensor 888 is generally positioned on the handle portions 822, 824, in the area where the hands are usually located when holding the apparatus 810.

In operation, the apparatus 810 provided with a sensor 888 may be integrated to the method for teaching a person in doing rotations which was described hereinabove. The sensor 888 is generally activated to help confirm to the user or an observer of the user that both hands 30, 36 are well positioned on the apparatus 810.

More specifically, the positioning of the second hand 36 on the handle portion 824 activates the sensor 888. At that time, the sensor 888 indicates via a signal that both hands are holding the apparatus 810. When the hand 36 holding the handle portion 824 releases the apparatus 810, which is illustrated in FIG. 23, the sensor is deactivated and stops emitting the signal.

A prototype of the apparatus 10, as illustrated in FIG. 1, was designed according to the following specifications:
The apparatus 10 includes in a diameter of about 2 centimeters and an overall length of about 15 to 20 centimeters;
A first handle portion 22 has an ellipsoidal cylinder shape of about 2 centimeters large, 1.5 centimeters thick and 8 centimeters long;
A second handle portion 24 has a an ellipsoidal cylinder shape of about 2 centimeters large, 1.5 centimeters thick and 8 centimeters long;
An articulation 40 having a cylinder shape of about 2 centimeters in diameter and of about 0.5 to 5 centimeters long;
A stopper 18 has an ellipsoidal shape of about 5 centimeters wide, 4.5 centimeters thick and 1.5 centimeters long;
A stopper 20 has a 2.5 centimeters diameter and being 2 centimeters long.

It is to be noted that the hereinabove sizes and proportion of the different components and portions are approximate and may vary accordingly, for example, to the size of the person using it.

Although the present invention has been described hereinabove by way of various embodiments thereof, it can be modified at will, without departing from the spirit and nature of the subject invention as defined in the appended claims.

1. An apparatus for training a person in doing rotations, the apparatus comprising:
a body having a first handle portion for receiving a first hand of the person and a second handle portion positioned adjacent said first handle portion for receiving a second hand of the person adjacent the first hand;
whereby, in operation, the person holds said first handle portion of the apparatus with said first hand before initiating a rotation and then holds both the first and second handle portions using both hands after initiating the rotation, to force both hands to being adjacent, thereby contributing to perfecting the rotation.

2. An apparatus as recited in claim 1, wherein each of said first and second handle portions has first and second longitudinal ends; said second handle portion is movably mounted to said second longitudinal end of said first handle portion via its first longitudinal end.

3. An apparatus as recited in claim 2, wherein said second handle portion is movably mounted to said first handle portion via an articulation.

4. An apparatus as recited in claim 3, wherein said first handle portion extends along a first axis and said second handle portion extends along a second axis such that upon operation of said articulation, said first axis and said second axis become secant.

5. An apparatus as recited in claim 1, wherein said first handle portion has first and second longitudinal ends and includes a stopper at said first longitudinal end.

6. An apparatus as recited in claim 5, wherein said stopper extends in a generally radial direction from said first handle portion to guide the positioning of the first hand.

7. An apparatus as recited in claim 5, wherein said stopper has a generally flared configuration.

8. An apparatus as recited in claim 5, wherein said first handle portion further comprises a strap.

9. An apparatus as recited in claim 8, wherein said strap includes an adjuster mounted to said stopper and so configured as to be inserted around a wrist of the first hand located on said first handle portion.

10. An apparatus as recited in claim 1, wherein said first handle portion further comprises a protrusion extending from said first handle portion along a radial direction to help position fingers when the first hand is positioned on said first handle portion.

11. An apparatus as recited in claim 1, wherein said second handle portion includes a stopper extending at one end thereof and in a generally radial direction from said second handle portion to guide the positioning of the second hand.

12. An apparatus as recited in claim 11, wherein said stopper has a generally protruding configuration along a portion of the circumference of said second handle portion.

13. An apparatus as recited in claim 1, wherein said apparatus further comprises an articulation pivotally mounting said first handle portion to said second handle portion and including a position selector assembly.

14. An apparatus as recited in claim 13, wherein said position selector assembly comprises a projection extending from said second handle portion which selectively cooperates with a plurality of notches on said first handle portion.

15. An apparatus as recited in claim 1, wherein said apparatus further comprises an articulation including a rotational body which is rotatably mounted along a first axis of said first handle portion and pivotally mounted to the second handle portion around a pin axis which is generally perpendicular to said first axis.

16. An apparatus as recited in claim 15, wherein said rotational body comprises on one end a plurality of notches cooperating with a projection extending from said second handle portion and on the other end, a mounting assembly which allows to selectively position said rotational body along said first axis.

17. An apparatus as recited in claim 1, wherein said apparatus further comprise an articulation including a deformable bar embedded in said first handle portion and said second handle portion and which deforms under a predetermined level of force.

18. An apparatus as recited in claim 1, wherein said apparatus further comprises an articulation including a joint body extending from one end of said first handle portion and so configured as to be inserted in a female portion of said second handle portion.

19. An apparatus as recited in claim 18, wherein said joint body supports a gear so configured as to mesh with a teeth receiving portion of said female portion and a an annular ring so configured as to cooperate with a ring receiving portion of said female portion.

20. An apparatus as recited in claim 19, wherein said gear comprises a plurality of teeth which generally extend along said joint body and being so configured as to selectively mesh in a plurality of grooves extending along said teeth receiving portion.

21. An apparatus as recited in claim 19, wherein said gear comprises one tooth which generally extends along said joint body and is so configured as to selectively mesh in a plurality of grooves extending along said teeth receiving portion.

22. An apparatus as recited in claim 19, wherein said annular ring comprises a plurality of plurality of rings made from a mechanically compliant material so configured as to selectively engage in a plurality of cavities along said ring receiving portion.

23. An apparatus as recited in claim 18, wherein said apparatus is longitudinally adjustable.

24. An apparatus as recited in claim 23, wherein said first handle portion and said second handle portion define an axis such that they are rotatably adjustable around said axis.

25. An apparatus as recited in claim 19, wherein said first handle portion and said second handle portion have generally ellipsoidal cross-sections.

26. An apparatus as recited in claim 1, wherein said first handle portion comprises a first stopper at one end and said second handle portion comprises a second stopper which is located adjacent to another end of said first handle portion.

27. An apparatus as recited in claim 26, wherein said first stopper and said second stopper are identical.

28. An apparatus as recited in claim 1, wherein said second handle portion comprises a stopper which is located adjacent to an end of said first handle portion.

29. An apparatus as recited in claim 1, wherein said apparatus further comprises an articulation including a telescopic body which movably mounts said first handle portion to said second handle portion.

30. An apparatus as recited in claim 29, wherein said first handle portion has a cross-section having a first greater axis and a first smaller axis and wherein said second handle portion has a cross-section having a second greater axis and a second smaller axis, said first greater axis being in a same plane as said second smaller axis and said first smaller axis being in a same plane as said second greater axis.

31. An apparatus as recited in claim 1, further comprising a sensor which is positioned on said second handle portion and an emitter connected to said sensor such that when the second hand is placed on said sensor, said emitter produces a signal.

32. An apparatus as recited in claim 1, wherein said body is hollow.

33. An apparatus as recited in claim 1, wherein said body is longitudinally extending and has a generally circular cross-section.

34. An apparatus as recited in claim 1, wherein said first and second handle portions have respective cross-sections which change in configuration along their respective lengths.

35. An apparatus for positioning both hands of a person while performing a body movement, said apparatus comprising:
a body including a first handle portion and a second handle portion which is movably mounted to said first handle portion; and
a stopper radially extending from said body near one end of said first handle portion;
whereby upon performing the body movement, a first hand is positioned on said first handle portion and in contact with said stopper, and the other hand is positioned on said second handle portion adjacent to the first hand.

36. A method for teaching a person in doing rotations, said method:
a) providing to the person a body having a first handle portion and a second handle portion positioned adjacent said first handle portion;
the person:
b) positioning a first hand on said first handle portion of said body;
c) generating the momentum to create the rotation along a rotation direction;
d) positioning a second hand on said second handle portion of said body and positioning both hands adjacent to one another in front of him;
e) bringing the hands holding said body close to him;
f) moving the arms from being generally in front of him in an opposite direction to said rotation direction; and
g) releasing the second hand from said second handle portion.

37. A method as claimed in claim 36, wherein the positioning of the second hand is accomplished at shoulders height and at a distance of about 35 cm in front of the person.

38. A method as claimed in claim 37, wherein the positioning of the second hand is accomplished with his arms generally forming a circle.

39. A method as claimed in claim 36, wherein said body comprises a sensor connected to an emitter which produces a signal which is activated at the positioning of the second hand and deactivated at the releasing of the second hand.

40. A method as claimed in claim 36, wherein the positioning of the second hand is accomplished with his elbows generally aligned.

41. A method as claimed in claim 36, wherein the bringing of the hands is generally performed at shoulder's height and at an equal distance of the shoulders.

42. A method as claimed in claim 36, wherein a landing side is defined has a side where the moving of the arms is performed and wherein the positioning of both hands is generally performed at shoulder's height and such that said body is held closer to his shoulder on said landing side.

43. A method as claimed in claim 36, wherein a landing side is defined has a side where the moving of the arms is performed and wherein the bringing of the hands is generally performed at shoulder's height and such that said body is held closer to his shoulder on said landing side.
